(19) United States
(12) Patent Application Publication
(10) Pub. No.: US 2018/0008515 A1
(43) Pub. Date: Jan. 11, 2018

(54) DEVICE FOR ADMINISTERING AN ACTIVE PRINCIPLE BY THE ORAL MUCOSAL ROUTE

(71) Applicants: Philippe PEROVITCH, Le Temple (FR); Marc MAURY, Saint Medard en Jalles (FR); Jack AUZERIE, Sainte-Eulalie (FR)

(72) Inventor: Philippe PEROVITCH, Le Temple (FR)

(21) Appl. No.: 15/544,762

(22) PCT Filed: Jan. 19, 2016
(86) PCT No.: PCT/FR2016/050097

§ 371 Date: Jul. 19, 2017

(30) Foreign Application Priority Data
Jan. 20, 2015 (FR) 1550429

(51) Int. Cl. A61J 7/00

(52) U.S. Cl. CPC A61J 7/0053

(57) ABSTRACT

A device for administering an active principle via the oral mucous membrane, having an ampule (1) containing liquid, the ampule including an opening defining a peripheral axial edge (11) closed by a film (10); a syringe barrel (2) with a dispenser orifice; a piston (3) in the syringe barrel (2); a piston rod (4); and a connector (20) formed integrally with or fastened to the syringe barrel (2) and adapted to be connected in leaktight manner to the ampule. The connector includes a perforator (23) for perforating the film and connecting the inside of the ampule with the syringe barrel, the perforator forming the dispenser orifice while the active principle is dispensed. The connector includes an outer protective skirt (21) for creating a gum/cheek cavity while the liquid is deposited and includes an annular reception space (24) for receiving the peripheral axial edge of the ampule.

The present invention relates to a device for administering an active principle via the oral mucous membrane, in particular a lipophilic active principle dissolved in a hydroalcoholic solution that is constituted of water and of ethanol.

The administration, via the oral mucous membrane, of lipophilic active principles in a hydroalcoholic solution with a high degree of ethanol, is described in documents WO 2008/035020, WO 2008/087323, WO 2009/095621, WO 2010/072950, WO 2010/081984, WO 2010/070236, WO 2011/004117, and also WO 2014/108657. Such administration is also the subject of scientific works and of international presentations and publications explaining its therapeutic effectiveness, specifically associated with the rapid absorption and systemic bioavailability of lipophilic active principles in hydroalcoholic solution administered at low dosage via the gum/cheek mucous membrane. Appropriate devices for preparing and dispensing such active principles are described in documents WO 2009/016309, WO 2009/138644, WO 2010/063978, and WO 2012/072934. In order to enable such hydroalcoholic solutions to be administered, said solutions should preferably be deposited in full and all at once, preferably in the anatomical groove between the gum and cheek, so as to guarantee the absorption of such small-volume solutions in a few seconds via the surface of the mucous membrane, so that once administered, the active principle is distributed instantaneously in the central then arterial blood circulation.

Numerous common active principles are stable in such hydroalcoholic solutions, i.e. active principles that need to be delivered inexpensively for use by patients at a cost that corresponds to the usual levels for pharmaceuticals on the market, such as those administered orally, and regardless of whether they are on prescription or over the counter (OTC).

The constraint of producing such hydroalcoholic therapeutic formulations at acceptable manufacturing and retail costs, is accompanied by the need to protect them from the phenomena of degradation, whether by light or by oxidization, for example, and specifically the packaging of such solutions must be of pharmaceutical quality and stable over time.

In addition, such solutions with their mucous-membrane application should be very simple to prepare and to apply in use, both for a care-giver and for any patient of ordinary competence, who often self-administers them.

Document WO 2007/014955 describes a glass ampule with a single opening that is provided with a sealed film on a circular rim, which film can be removed by pulling on an outer tab, said film alternatively being perforated by a straw, thereby making it easy to extract all of the liquid by sucking it up, as with a drink.

Hydroalcoholic solutions for administering via the oral mucous membrane, and conveying lipophilic active principles that have been put into solution, are very small in volume, preferably less than 2 milliliters (mL). With volumes that are so small, e.g. for 2 mL film-sealed ampule, it is difficult or impossible to deposit the solution accurately and completely in the groove between a patient's gum and cheek with a single manipulation of such a small ampule, regardless of its shape. Specifically, some liquid is retained at the neck of the ampule on which the film is sealed. Even when the film is entirely perforated or detached from the orifice, the surface tension that is exerted by the hydroalcoholic solution on said glass rim of the neck of the small ampule remains an obstacle to delivering the hydroalcoholic medicated solution as desired in easy, complete, and instantaneous manner, particularly given the small volume of solution contained in the ampule, since the liquid is not heavy enough to rupture the surface tension at the orifice that retains the flow. In such conditions, it is very difficult or impossible to dispense the entire contents of such an ampule accurately in the anatomic gum/cheek zone level with the premolars and the molars of the bottom jaw, while holding said ampule between finger tips. It is also impossible to deliver a very accurate fraction of the active principle present in solution, e.g. a dose that is measured to within one tenth of a milligram, as a function of the patient, of the patient's weight, and/or of the patient's age.

Documents WO 0 057 835, EP 1 378 223, JP 2005/143677, US 2005/159724, U.S. Pat. No. 5,921,419, and EP 0 499 481 describe other prior-art devices.

An object of the present invention is to overcome the above-mentioned drawbacks.

In particular, an object of the present invention is to enable small-volume film-sealed ampules to be produced easily, so as to deliver medicated hydroalcoholic solutions via the oral mucous membrane.

Another object of the present invention is to enable the dose of active principle to be administered to be measured exactly, and for it to be administered instantaneously and without any loss.

Another object of the present invention is to propose a device for administering an active principle via the oral mucous membrane, which device, by its particular shape, protects the mucous tissues of the groove between the gum and the cheek from any trauma or damage during administration.

Another object of the present invention is to propose a device for administering an active principle via the oral mucous membrane that is simple and inexpensive to manufacture and to assemble, and that is reliable in use.

The present invention thus provides a device for administering an active principle via the oral mucous membrane, the device comprising:
an ampule containing a liquid, said ampule including a single opening that defines a peripheral axial edge and that is closed by a film;
a syringe barrel provided with a dispenser orifice for dispensing said at least one active principle on the gum/cheek mucous membranes;
a piston contained in said syringe barrel;
a piston rod connected to said piston for moving said piston in said syringe barrel; and
a connector that is formed integrally with or fastened to said syringe barrel, said connector being adapted to be connected in leaktight manner to said ampule, said connector including an inner perforator for perforating said film of said ampule and for connecting the inside of said ampule with said syringe barrel, said inner perforator forming said dispenser orifice of the syringe barrel while the active principle is being dispensed on said gum/cheek mucous membranes, said connector further including an outer protective skirt for creating a gum/cheek cavity by moving the cheek mucous membrane away from the gum mucous membrane while said liquid is being deposited and completely absorbed, said outer protective skirt surrounding said inner perforator, and said connector including an annular reception space for receiving said peripheral axial edge of said ampule, said annular reception space being defined between the inner perforator and said outer protective skirt.

Advantageously, said syringe barrel and said connector are formed as a single piece.

In a variant, said syringe barrel and said connector are formed separately, said connector including fastener means for fastening said connector to said syringe barrel.

Advantageously, said fastener means comprise screw-fastener or snap-fastener means.

Advantageously, said fastener means comprise blocking means, such as a groove, that fasten said connector firmly on said syringe barrel.

Advantageously, said perforator includes an end of shape that is blunt and non-aggressive.

Advantageously, said outer protective skirt includes an outer shape that is rounded, in particular hemispherical.

Advantageously, said syringe barrel includes graduations, enabling dosing to be accurate, in particular to within 0.01 mL.

Advantageously, said syringe barrel includes a movable slider, in particular a lockable slider, making it possible to determine a marker for the reference dose that should be administered.

Advantageously, said ampule contains a hydroalcoholic solution that is constituted of water and of ethanol, preferably with 40% to 60% of ethanol and 60% to 40% of water.

Advantageously, said ampule contains an active principle dissolved in said hydroalcoholic solution.

Advantageously, the volume of said ampule lies in the range 0.5 mL to 2 mL.

These characteristics and advantages and others of the present invention appear more clearly from the following detailed description, given by way of non-limiting examples, and with reference to the accompanying drawing, and in which:

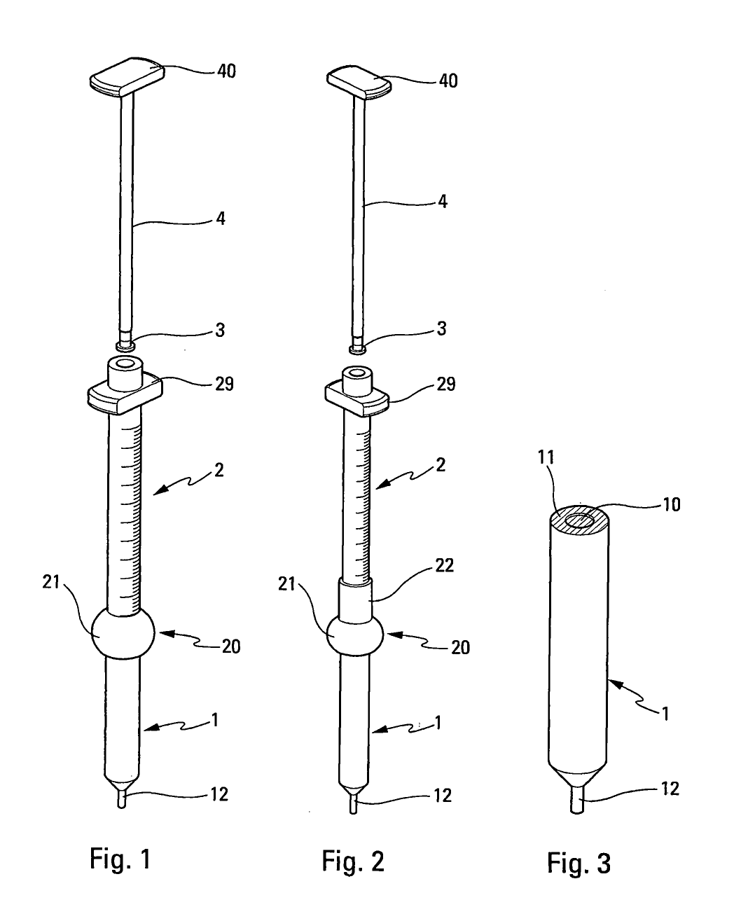

FIG. 1 is an exploded view of a device for administering an active principle via the oral mucous membrane in a first advantageous embodiment of the invention;

FIG. 2 is a view similar to the view in FIG. 1, showing a second advantageous embodiment of the invention;

FIG. 3 is a perspective view of a detail of a film-sealed ampule;

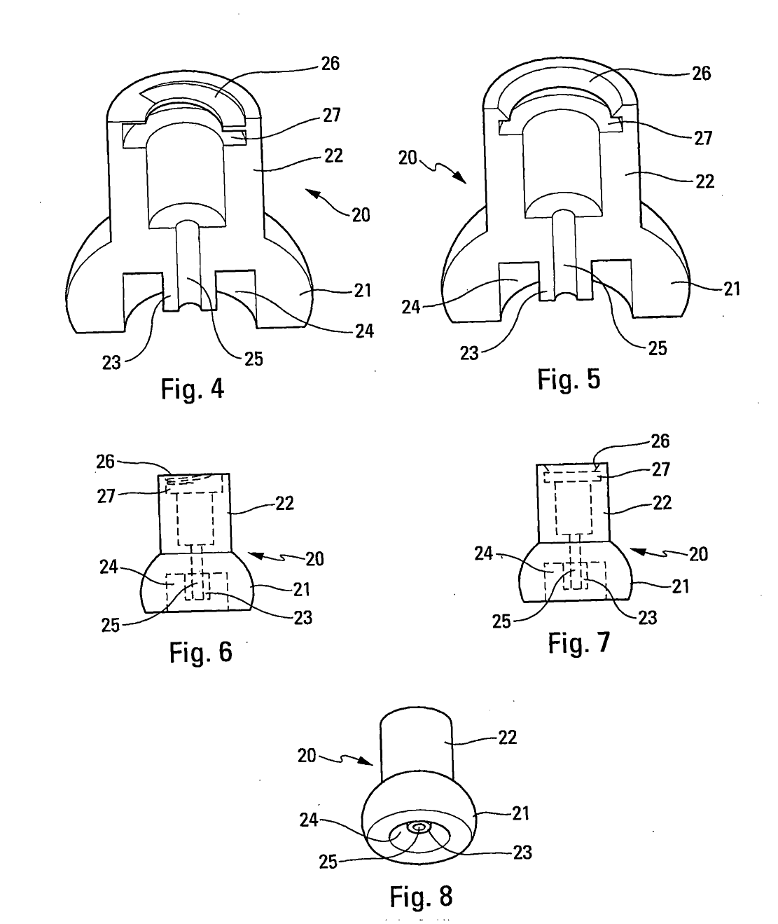

FIG. 4 is a cut-away perspective view of a detail of the FIG. 3 connector in a first advantageous variant embodiment of the device;

FIG. 5 is a view similar to the view in FIG. 4, showing a second advantageous variant embodiment of the connector;

FIG. 6 is a diagrammatic section view of the FIG. 4 connector;

FIG. 7 is a diagrammatic section view of the FIG. 5 connector;

FIG. 8 is a three-fourths perspective view from below of a connector of the FIG. 2 second embodiment of the invention; and

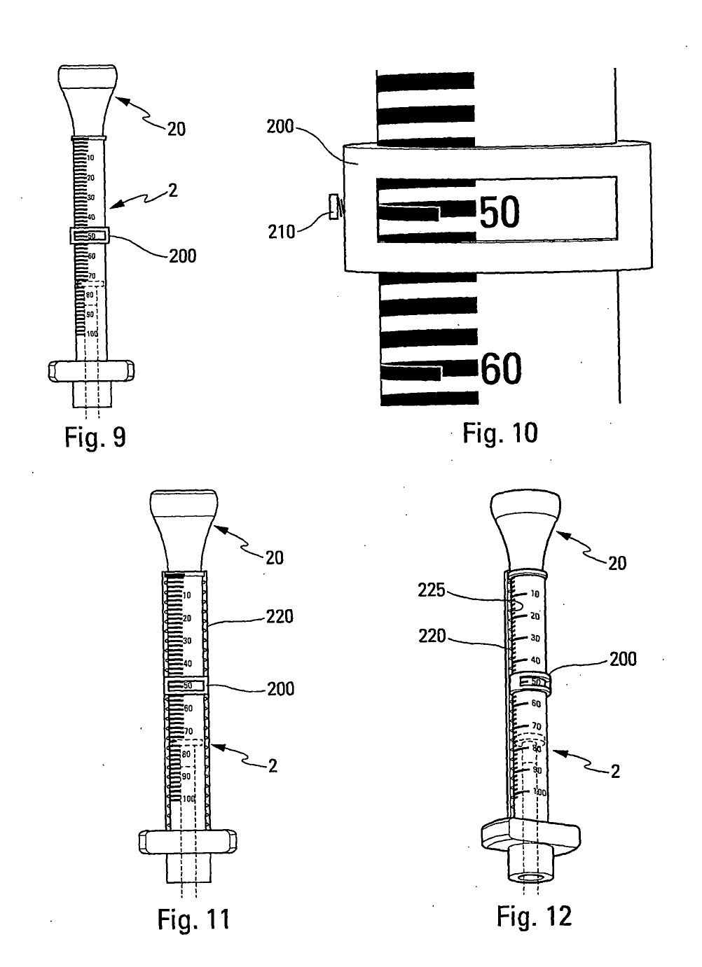

FIGS. 9 to 12 are diagrammatic views showing other variant embodiments.

In order to make the drawings clear, the proportions are not necessarily to scale. In addition, FIGS. 1 to 3 show the administering device in its upright position, with the syringe above the ampule. However, it is understood that in use, when the user draws in fluid contained in the ampule so as to transfer it into the syringe, it is preferable for the administering device to be in its upsidedown position, with the ampule above the syringe, so as to avoid air being drawn in.

The present invention applies more particularly to active principles of lipophilic nature, dissolved in a hydroalcoholic solution. The hydroalcoholic solution is preferably constituted exclusively of water and of ethanol. Advantageously, the hydroalcoholic solution lies in the range 40% to 60% by volume of ethanol, and in the range 60% to 40% by volume of water.

With reference to FIG. 1, an advantageous first embodiment of the invention is described below.

In this first embodiment, the device comprises four components: a film-sealed ampule 1 having a volume that preferably lies in the range 0.5 mL to 2 mL; a syringe barrel 2; a piston 3; and an actuator rod 4 that co-operates with said piston 3 so as to cause it to slide in leaktight manner in said syringe barrel 2. Advantageously, said piston 3 may be formed of a sealing gasket that is positioned at the end of said actuator rod 4.

The ampule 1, visible in FIG. 3, includes a single opening that defines a peripheral axial edge 11, said opening being closed by a film 10. Said film 10 is perforable and preferably cannot be peeled off. The end 12 of the ampule 1, remote from said film-sealed opening 11 and typically made in the shape of a tapering tip of the ampule, is advantageously free, and may possibly be held by the user of the device while said ampule 1 is being inserted into the connector 20 of the above-described syringe barrel 2.

At one end, the syringe barrel 2 includes a connector 20 that is adapted to be connected to said ampule 1 and, at its other end, a radial flange 29 that forms a finger rest during actuation.

In this first embodiment, said connector 20 is formed integrally with said syringe barrel.

The syringe barrel 2 further includes graduations, enabling dosing to be very accurate, in particular to within 0.01 mL, thereby making it possible for the dose of the active principle that is administered to be adjusted with high accuracy relative to the desired therapeutic action. Advantageously, said syringe is specifically graduated for metering only one single active principle in hydroalcoholic solution, that is to be administered via the gum/cheek. In particular, the precise dose that is to be administered via the gum/cheek may be taken from said film-sealed ampule and adjusted to within at least one fiftieth of a milliliter.

Advantageously, a movable slider 200 may exist around the syringe barrel 2, around the graduation of the syringe. Preferably, the slider 200 is lockable in a fixed position, thereby making it possible to mark the precise dose that is to be administered or that must not be exceeded, so that the user takes the determined doses on each occasion. By way of example, the cursor 200 may be locked with an outer clamping screw 210, as shown diagrammatically in the embodiment in FIG. 10. In a variant, the cursor 200 may slide along a side rail 220 that is secured to the syringe 2 or to the connector 20, the slider 200 becoming blocked against sharp edges of notches 225 that are present in the side rail 220. By way of example, the notches 225 may be of stair-case or square type, or they may be holes in which the slider 200 becomes clipped. In still another variant, the slider may merely slide with friction over the syringe barrel.

Said connector 20 includes an inner perforator 23 for perforating said film 10 of said ampule, and for connecting, in this way, the inside of said ampule 1 with said syringe barrel 2. Said inner perforator 23 includes a channel 25, and forms the dispenser orifice of the syringe barrel 2 while dispensing the active principle on said gum/cheek mucous membranes.

Said connector 20 further includes an outer protective skirt 21 that surrounds said inner perforator 23. The protective skirt 21 surrounds said inner perforator 23, and advantageously includes an outer shape that is rounded, in particular hemispherical, so as to avoid any risk of injury when it comes into contact with the groove between the gum and the cheek. In particular, the rounded shape makes it possible to move the patient's cheek away from the facing gum and thus maintain said offset, forming a wide channel while the hydroalcoholic solution of the active principle flows into said groove between the gum and the cheek, preventing said anatomical mucous membrane cavity suffering any trauma or irritation. In particular, after taking the hydroalcoholic solution from the ampule 1 in exact and duly measured manner, the present invention makes it possible to move the cheek mucous membrane away from the gum mucous membrane by means of the connector 20, for momentarily creating the mucous membrane cavity for receiving the hydroalcoholic deposit, so as to enable it to be deposited and absorbed.

Advantageously, the dimensions of the connector 20 may be suitable for administering to young children.

The connector 20 also includes an annular reception space 24 for receiving, advantageously in leaktight manner, the peripheral axial edge 11 of the ampule 1, said annular reception space 24 being defined between said inner perforator 23 and said outer protective skirt 21.

Advantageously, said perforator 23 has a shape that is blunt and non-aggressive, and that perforates said film by force. In a variant, said perforator could include an end that is pointed and/or sharp and/or jagged, so as to facilitate perforating said ampule 1. Naturally, since said protective skirt 21 surrounds said cutting end, any risk of injury is avoided.

The present invention thus makes it possible, after perforating the film 10, firstly to take the hydroalcoholic solution accurately from the ampule 1 by measuring the dose to be administered, and secondly to deliver said dose into the groove between the gum and the cheek, for instantaneous and complete mucous-membrane absorption of said dose. Such complete absorption typically takes 3 seconds to 10 seconds, depending on the volume of solution that has been administered.

It should be observed that after a dose has been taken and administered onto a patient's gum/cheek, the connector 20 may once again be connected to the ampule 1, thereby making it possible to close the ampule in leaktight manner, and prevent the ethanol of the hydroalcoholic solution of the ampule from evaporating. In this way, it is possible to preserve the doses remaining in the ampule for a certain period of time, and if necessary to take it once again for the same patient who has already been treated, if it seems necessary to take another precise dose of the active principle and to administer it. This makes it possible to conserve doses for a certain period of time, since the end specific to the syringe of the invention serves as a stopper, while continuing to be available for administering a new dose easily.

FIGS. 2 and 4 to 8 show a second embodiment in which said syringe barrel 2 and said connector 20 are formed separately, said connector 20 including fastener means 26, 27 for fastening said connector 20 to said syringe barrel 2.

The connector 20 comprises a sleeve 22 that incorporates said fastener means and that is extended by said outer protective skirt 21.

Advantageously, said fastener means comprise screw-fastener or snap-fastener means 26.

Preferably, the fastener means are permanent, i.e. after fastening, the connector can no longer be separated from the syringe barrel.

FIGS. 4 and 6 show screw-fastener means, and FIGS. 5 and 7 show snap-fastener or clipping means.

Preferably, said fastener means comprise blocking means 27, such as a groove, that fasten said connector 20 firmly on said syringe barrel 2. This makes it possible, in an emergency situation, to avoid said connector 20 becoming separated from the syringe barrel 2 and thus constituting an item that might become detached in the mouth and/or throat cavity, with a risk of choking while going down the wrong passage.

Advantageously, said removable connector could also be provided with a stopper, e.g. formed by a suitable movable accessory, so as to form a leaktight stopper device for the opening of the ampule, thereby preserving the alcoholic quality from potentially evaporating.

Various modifications are possible for the skilled person without departing from the scope of the present invention as defined in the accompanying claims.

1. A device for administering an active principle via the oral mucous membrane, the device being characterized in that it comprises:
an ampule containing a liquid, said ampule including a single opening that defines a peripheral axial edge and that is closed by a film;
a syringe barrel provided with a dispenser orifice for dispensing said at least one active principle on the gum/cheek mucous membranes;
a piston contained in said syringe barrel;
a piston rod connected to said piston for moving said piston in said syringe barrel; and
a connector that is formed integrally with or fastened to said syringe barrel, said connector being adapted to be connected in leaktight manner to said ampule, said connector including an inner perforator for perforating said film of said ampule and for connecting the inside of said ampule with said syringe barrel, said inner perforator forming said dispenser orifice of the syringe barrel while the active principle is being dispensed on said gum/cheek mucous membranes, said connector further including an outer protective skirt for creating a gum/cheek cavity by moving the cheek mucous membrane away from the gum mucous membrane while said liquid is being deposited and completely absorbed, said outer protective skirt surrounding said inner perforator, and said connector including an annular reception space for receiving said peripheral axial edge of said ampule, said annular reception space being defined between the inner perforator and said outer protective skirt.

2. The device according to claim 1, wherein said syringe barrel and said connector are formed as a single piece.

3. The device according to claim 1, wherein said syringe barrel and said connector are formed separately, said connector including fastener means for fastening said connector to said syringe barrel.

4. The device according to claim 3, wherein said fastener means comprise screw-fastener or snap-fastener means.

5. The device according to claim 3, wherein said fastener means comprise blocking means, such as a groove, that fasten said connector firmly on said syringe barrel.

6. The device according to claim 1, wherein said perforator includes an end of shape that is blunt and non-aggressive.

7. The device according to claim 1, wherein said outer protective skirt includes an outer shape that is rounded, in particular hemispherical.

8. The device according to claim 1, wherein said syringe barrel includes graduations, enabling dosing to be accurate, in particular to within 0.01 mL.

9. The device according to claim 1, wherein said syringe barrel includes a movable slider, in particular a lockable slider, making it possible to determine a marker for the reference dose that should be administered.

10. The device according to claim 1, wherein said ampule contains a hydroalcoholic solution that is constituted of water and of ethanol, preferably with 40% to 60% of ethanol and 60% to 40% of water.

11. The device according to claim 10, wherein said ampule contains an active principle dissolved in said hydroalcoholic solution.

12. The device according to claim 1, wherein the volume of said ampule lies in the range 0.5 mL to 2 mL.
